(19) United States
(12) Patent Application Publication
(10) Pub. No.: US 2025/0353791 A1
(43) Pub. Date: Nov. 20, 2025

(54) CONCRETE MIXTURES AND METHODS OF MAKING THE SAME

(71) Applicant: THE BOARD OF TRUSTEES OF THE UNIVERSITY OF ALABAMA, Tuscaloosa, AL (US)

(72) Inventor: Jialai Wang, Tuscaloosa, AL (US)

(21) Appl. No.: 18/871,617

(22) PCT Filed: May 26, 2023
(86) PCT No.: PCT/US2023/023648

§ 371 Date: Dec. 4, 2024

Related U.S. Application Data
(60) Provisional application No. 63/349,261, filed on Jun. 6, 2022.

(51) Int. Cl. C04B 28/10; C04B 22/10; C04B 24/06; C04B 40/00; C04B 111/00

(52) U.S. Cl. CPC C04B 28/105; C04B 22/103; C04B 24/06; C04B 40/0046; C04B 2111/00019; C04B 2201/50

(57) ABSTRACT

Disclosed herein is a composition comprising a) of about 80 wt % to about 99 wt % of a cementitious material; b) of about 0.05 wt % to about 3 wt % of a water-soluble organic compound and/or salts thereof, and c) of about 1 wt % to about 20 wt % of carbon dioxide. Additionally, articles comprising the disclosed herein composition are also disclosed. Also disclosed are methods of making the compositions and the articles.

### CROSS-REFERENCE TO RELATED APPLICATIONS

This application claims the benefit of U.S. Provisional Application No. 63/349,261, filed Jun. 6, 2022, the content of which is incorporated herein by reference in its entirety.

### FIELD

The subject matter disclosed herein generally relates to concrete having increased strength. Also, the subject matter described herein generally relates to methods of making strengthened concrete using CO₂ as a strength enhancer through a pre-carbonation process regulated by a water-soluble organic compound and/or salts thereof.

### BACKGROUND

Concrete using Ordinary Portland Cement (OPC) as the binder is the most widely used construction material. The global use of concrete is second only to water, accounting for 70% of all building and construction materials. Although OPC has many advantages, such as ease of application and availability of raw materials around the world, the production of OPC releases a large amount of greenhouse gases, such as carbon dioxide (CO₂). One ton of OPC clinker production emits at least 0.9-0.95 tons of CO₂, 60% of which is emitted from the calcination process of limestone, with the rest coming from fuel combustion in the kiln. In fact, cement production in the U.S. accounts for up to 8% of the nation's total CO₂ emission.

This is unsustainable energy and CO₂ burden, especially for a material manufactured at the scale of >4.5 billion tons per year. To reduce the carbon emission created by cement and concrete, the United Nations Environment Program Sustainable Building and Climate Initiative (UNEP-SBCI) has identified three effective approaches: (a) increasing the use of supplementary cementitious materials (SCMs); (b) developing sustainable alternative cements, and (c) improving cement efficiency. UNEP-SBCI pointed out that the International Energy Agency's 2050 goal of CO₂ emissions reduction from the cement industry by 24% compared to current levels (with an expected increase of 12-23% in global cement production) is too rigorous to be addressed by single approaches.

Reducing the amount of OPC used in concrete can be realized through partially replacing OPC with supplementary cementitious materials (SCMs) or totally replacing OPC with alternative non-OPC binders, which have a lower carbon footprint than OPC including magnesia cement, sulfoaluminate cements, blended OPC-based cements, and geopolymers. Commonly used SCMs, such as fly ash, grounded blast-furnace slag, and cement kiln dust, are calcium-rich industrial wastes. They can hydrate and/or react with hydration products of OPC and thereby enhance the long-term properties of concrete. However, these reactive SCMs can also create new problems in concrete with respect to retardation, delayed setting time, and low early-age strength.

Non-reactive SCMs, especially ground limestone (mainly calcite (CaCO₃)), are also used to partially replace OPC. Due to the additional surface area provided by the limestone powders for the nucleation and growth of the hydration products, a slight acceleration of the hydration of OPC has been observed with the addition of CaCO₃. In addition, CaCO₃ can be reactive. It can have limited reactivity with the aluminate phases of OPC. Thermodynamic simulation and experimental studies show that CaCO₃ can alter the hydration products and stabilize ettringite, leading to an increase in the total volume of the hydrate phase, which can reduce the porosity of hardened concrete. Therefore, limited replacement (less than 10%) of OPC by limestone can impact concrete's short and long-term performance. Since some reactive SCMs, such as fly ash, contain an aluminate phase, they can be used together with limestone powders to form blended SCMs. A successful application of such blended SCMs is ternary cement, in which blended SCMs consisting of fly ash and limestone can be used to partially replace OPC. Due to the synergistic effect induced by the limited reaction between the limestone powders and aluminate phase in reactive SCMs, the ternary cement using blended SCMs works better than the binder using individual SCMs. However, the use of limestone powder is limited to low replacement levels. At higher replacement levels (more than 10-15% of OPC), most of the limestone is non-reactive, and the strength of the concrete is reduced due to the dilution effect of the limestone powder. Thus, the replacement of OPC with an SCM typically results in some reduction in the strength or the durability of the manufactured concrete.

A second possible way to reduce the carbon footprint in concrete manufacturing is to reabsorb the emitted CO₂. CO₂ emitted during the manufacturing of OPC can be naturally reabsorbed in concrete products through a natural chemical reaction. However, the natural process is relatively slow, and it can take hundreds of years to reabsorb all the CO₂ during the production of an equivalent amount of concrete. In addition, carbonation is detrimental to concrete because it can cause corrosion of the steel reinforcement present in many concrete applications. However, carbonating concrete at an early age and high concentration and pressure of CO₂ can significantly accelerate the strength development of concrete, as shown in some studies. Here, early-age concrete specimens are cured in a closed chamber full of CO₂ gas. After diffusing into the concrete specimen, CO₂ gas can react with fresh concrete and transform into solid calcium carbonates (CaCO₃) stored permanently in concrete. Reabsorbing CO₂ in concrete is an example of a general concept of storing CO₂ permanently in the form of thermodynamically stable carbonates through a chemical reaction between CO₂ and reactive metal oxides. In addition to cement and concrete, numerous other minerals and industrial wastes have been evaluated to store CO₂.

Although using high concentrations and pressures of CO₂ can increase the speed of the carbonation, the reaction rate of carbonation can be the major obstacle to this technique. This is because the carbonation reaction rate of early-age concrete can be limited by the diffusion of the gaseous CO₂ into the concrete matrix, which can be very slow. In addition, the carbonation products, CaCO₃ particles, can fill the pores in the concrete matrix so that the diffusion of CO₂ becomes more difficult as the carbonation reaction progresses. Therefore, existing studies on carbonation curing of concrete are limited to concrete specimens with a small thickness so that diffusion of CO₂ to the full depth of the specimen is possible in a short period. In addition, the degree of carbonation varies at different depths from the surface and thereby affects the properties of concrete. Excessive carbon curing can destroy calcium silicate hydrate (CSH), the major hydration product and binding agent of OPC, thereby reducing the strength of concrete. Consequently, the theoretical CO₂ absorption of concrete can never be reached if the strength of concrete must be maintained. Also, since a closed curing chamber is needed, carbonation curing technology is usually applicable to only precast concrete.

Thus, new methods and compositions are needed to reduce the carbon footprint of concrete manufacture. Such compositions and methods should also permit the strength and durability of the concrete to be maintained while eliminating the difficulties encountered in existing approaches. The compositions and methods disclosed herein address these and other needs.

### SUMMARY

In accordance with the purposes of the disclosed materials, compounds, compositions, and methods, as embodied and broadly described herein, the disclosed subject matter, in one aspect, relates to compounds and compositions and methods for preparing and using such compounds and compositions.

In some aspects disclosed herein is a composition comprising a) about 80 wt % to about 99 wt % of a cementitious material; b) about 0.05 wt % to about 3 wt % of a water-soluble organic compound and/or salts thereof, and c) about 1 wt % to about 20 wt % of carbon dioxide.

In some aspects, the water-soluble organic compound and/or salts thereof can comprise at least one oxygen containing functional group along a main chain or a branched chain.

Also disclosed herein are articles comprising the disclosed herein compositions. In such exemplary and unlimiting aspects, the article can comprise a concrete, a tile, a brick, a paver, a panel, a synthetic stone, or any combination thereof.

In some aspects, disclosed herein is a method of forming a composition comprising: a) contacting a first cementitious material with a water-soluble organic compound and/or salts thereof to form a first slurry; b) contacting the first slurry with a carbon-dioxide-rich gas to form a second slurry, and c) adding a second cementitious material to the second slurry to form the composition. In such exemplary and unlimiting aspects, the formed composition can comprise a) a total of about 80 wt % to about 99 wt % cementitious material comprising both the first and second cementitious material; b) about 0.05 wt % to about 3 wt % of a water-soluble organic compound and/or salts thereof; and c) about 1 wt % to about 20 wt % of carbon dioxide.

Also disclosed herein is a method of forming a composition comprising a) contacting a first cementitious material with a water-soluble organic compound and/or salts thereof to form a first slurry; b) contacting a first slurry with a carbon-dioxide-rich gas to form a second slurry; wherein the second slurry comprises carbonates, and c) drying and grinding the second slurry into fine powders with a size smaller than about 0.15 mm to form the composition.

Also disclosed is a method comprising: a) providing any of the disclosed herein compositions; and b) forming an article.

Also disclosed herein is a method of forming a composition comprising: a) mixing a washing water with a waste concrete comprising a first cementitious material to form a diluted mixture of the waste concrete; b) removing aggregates from the mixture of the waste concrete to form a waste concrete slurry; c) contacting a waste concrete slurry with a water-soluble organic compound and/or salts thereof to form a first slurry; d) contacting the first slurry with a carbon-dioxide-rich gas to form a second slurry; and e) adding a second cementitious material to the second slurry to form the composition.

Additional advantages will be set forth in part in the description that follows and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 is a schematic that illustrates the process of forming an exemplary article in one aspect.

FIG. 2 depicts an SEM image of nanoparticles formed in concrete in one aspect.

FIG. 3 depicts the compressive strength of the cement mortars made with an exemplary method in one aspect.

FIG. 4 depicts the compressive strength of the cement mortars made with an exemplary method in another aspect.

FIG. 5 depicts a TGA analysis of an exemplary concrete.

FIG. 6 depicts the isothermal calorimetry result of three cement pastes with a water-to-cement ratio=0.5.

FIG. 7 depicts the compressive strengths of exemplary concretes in one aspect.

### DETAILED DESCRIPTION

The materials, compounds, compositions, articles, and methods described herein may be understood more readily by reference to the following detailed description of specific aspects of the disclosed subject matter and the Examples included therein.

Before the present materials, compounds, compositions, kits, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entirety are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings:

As used herein, the terms “optional” or “optionally” means that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The term “or” means “and/or.” Recitation of ranges of values is merely intended to serve as a shorthand method of referring individually to each separate value falling within the range unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

Recitation of ranges of values herein is merely intended to serve as a shorthand method of referring individually to each separate value recited or falling within the range unless otherwise indicated herein, and each separate value is incorporated into the specification as if it were individually recited. Ranges provided herein are understood to be shorthand for all of the values within the range. For example, a range of 1 to 50 is understood to include any number, or combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40,41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

The organic moieties mentioned when defining variable positions within the general formulae described herein (e.g., the term “halogen”) are collective terms for the individual substituents encompassed by the organic moiety. The prefix Cₙ₋ₘ preceding a group or moiety indicates, in each case, the possible number of carbon atoms in the group or moiety that follows.

The term “ion,” as used herein, refers to any molecule, portion of a molecule, a cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, a portion of a molecule, a cluster of molecules, a molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), a cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), a cluster of molecules, molecular complex, moiety, or atom, containing a net positive charge or that can be made to contain a net positive charge. The term “cation precursor” is used herein to specifically refer to a molecule that can be converted to a cation via a chemical reaction (e.g., protonation or alkylation).

As used herein, the term “substituted” means that a hydrogen atom is removed and replaced by a substituent. It is contemplated to include all permissible substituents of organic compounds. As used herein, the phrase “optionally substituted” means unsubstituted or substituted. It is understood that substitution at a given atom is limited by valency. In a broad aspect, the permissible substituents include acyclic and cyclic, branched and unbranched, carbocyclic and heterocyclic, and aromatic and nonaromatic substituents of organic compounds and/or salts thereof. Illustrative substituents include, for example, those described below. The permissible substituents can be one or more and the same or different for appropriate organic compounds and/or salts thereof. For purposes of this disclosure, the heteroatoms, such as nitrogen, can have hydrogen substituents and/or any permissible substituents of organic compounds and/or salts thereof described herein, which satisfy the valencies of the heteroatoms. This disclosure is not intended to be limited in any manner by the permissible substituents of organic compounds and/or salts thereof. Also, the terms “substitution” or “substituted with” include the implicit proviso that such substitution is in accordance with a permitted valence of the substituted atom and the substituent and that the substitution results in a stable compound, e.g., a compound that does not spontaneously undergo transformation such as by rearrangement, cyclization, elimination, etc. In still further aspects, it is understood that when the disclosure describes a group being substituted, it means that the group is substituted with one or more (i.e., 1, 2, 3, 4, or 5) groups as allowed by valence selected from alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

“Z¹,” “Z².” “Z³,” and “Z⁴” are used herein as generic symbols to represent various specific substituents. In certain aspects, the generic symbols to represent various specific substituents can be marked as “R¹,” “R²,” “R³,” or “R”,” wherein n is a subsequent number of substituents. These symbols can be any substituent, not limited to those disclosed herein, and when they are defined to be certain substituents in one instance, they can, in another instance, be defined as some other substituents.

The expressions “ambient temperature” and “room temperature” as used herein are understood in the art and refer generally to a temperature, e.g., a reaction temperature, that is about the temperature of the room in which the reaction is carried out, for example, a temperature from about 20° C. to about 30° C.

A dash (“-”) that is not between two letters or symbols is used to indicate a point of attachment for a substituent. For example, —(C═O)NH₂ is attached through the carbon of the keto (C═O) group.

The term “aliphatic,” as used herein, refers to a non-aromatic hydrocarbon group and includes branched and unbranched, alkyl, alkenyl, or alkynyl groups. As used herein, the term “Cₙ-Cₘ alkyl” (or “Cₙ-m”) employed alone or in combination with other terms refers to a saturated hydrocarbon group that may be straight-chain or branched, having n to m carbons. It is understood that the terms Cₙ-m and Cₙ-Cₘ can be used interchangeably and just to show that the specific compound has between n to m carbons. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl moieties include but are not limited to, chemical groups such as methyl, ethyl, n-propyl, isopropyl, n-butyl, teri-butyl, isobutyl, sec-butyl; higher homologs such as 2-methyl-I-butyl, n-pentyl, 3-pentyl, n-hexyl, 1,2,2-trimethylpropyl, heptyl, octyl, nonyl, decyl, dodecyl, tetradecyl, hexadecyl, eicosyl, tetracosyl, and the like. The alkyl group can also be substituted or unsubstituted. Throughout the specification, “alkyl” is generally used to refer to both unsubstituted alkyl groups and substituted alkyl groups; however, substituted alkyl groups are also specifically referred to herein by identifying the specific substituent(s) on the alkyl group. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below, provided that the substituents are sterically compatible and the rules of chemical bonding and strain energy are satisfied.

The term “heteroaliphatic” refers to an aliphatic moiety that contains at least one heteroatom in the chain, for example, an amine, carbonyl, carboxy, oxo, thio, phosphate, phosphonate, nitrogen, phosphorus, silicon, or boron atoms in place of a carbon atom. In certain embodiments, the only heteroatom is nitrogen. In certain embodiments, the only heteroatom is oxygen. In certain embodiments, the only heteroatom is sulfur. “Heteroaliphatic” is intended herein to include, but is not limited to, heteroalkyl, heteroalkenyl, heteroalkynyl, heterocycloalkyl, heterocycloalkenyl, and heterocycloalkynyl moieties. In certain embodiments, “heteroaliphatic” is used to indicate a heteroaliphatic group (cyclic, acyclic, substituted, unsubstituted, branched, or unbranched) having 1-20 carbon atoms. In certain embodiments, the heteroaliphatic group is optionally substituted in a manner that results in the formation of a stable moiety. Nonlimiting examples of heteroaliphatic moieties are polyethylene glycol, polyalkylene glycol, amide, polyamide, polylactide, polyglycolide, thioether, and ether, alkyl-heterocycle-alkyl, —O-alkyl-O-alkyl, alkyl-O-haloalkyl, etc.

Throughout the specification, “alkyl” is generally used to refer to both unsubstituted alkyl groups and substituted alkyl groups; however, substituted alkyl groups are also specifically referred to herein by identifying the specific substituent(s) on the alkyl group. It is understood that alkyl groups can be used as a linking group, in such aspects, the alkyl group also includes divalent alkylene groups. The term alkyl also includes alkyls having multiple substitutions.

For example, the term “halogenated alkyl” specifically refers to an alkyl group that is substituted with one or more halides, e.g., fluorine, chlorine, bromine, or iodine. Haloalkyl” is a branched or straight-chain alkyl group substituted with 1 or more halo atoms described above, up to the maximum allowable number of halogen atoms. Examples of haloalkyl groups include but are not limited to, fluoromethyl, difluoromethyl, trifluoromethyl, chloromethyl, dichloromethyl, trichloromethyl, pentafluoroethyl, heptafluoropropyl, difluorochloromethyl, dichlorofluoromethyl, difluoroethyl, difluoropropyl, dichloroethyl and di chloropropyl. “Perhaloalkyl” means an alkyl group having all hydrogen atoms replaced with halogen atoms. Examples include but are not limited to trifluoromethyl and pentafluoroethyl.

The term “alkoxyalkyl” specifically refers to an alkyl group that is substituted with one or more alkoxy groups, as described below. The term “alkylamino” specifically refers to an alkyl group that is substituted with one or more amino groups, as described below and the like. When “alkyl” is used in one instance, and a specific term such as “alkylalcohol” is used in another, it is not meant to imply that the term “alkyl” does not also refer to specific terms such as “alkylalcohol” and the like.

As used herein, “Cₙ-Cₘ alkenyl” refers to an alkyl group having one or more double carbon-carbon bonds and having n to m carbons. Alkenyls can be straight-chained or branched. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Examples of alkenyl groups include but are not limited to, ethenyl, n-propenyl, isopropenyl, n-butenyl, seobutenyl, and the like. In various aspects, the alkenyl moiety contains 2 to 6, 2 to 4, or 2 to 3 carbon atoms. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, cyano, silyl, sulfo-oxo, sulfonyl, sulfone, sulfoxide, thiol, thiol, or phosphonyl, as described below. It is understood that alkenyl groups can be used as linking groups, in such aspects, the alkenyl group also includes divalent alkenylene groups. The term alkenyl also includes alkenyls having multiple substitutions.

As used herein, “Cₙ-Cₘ alkynyl” refers to an alkyl group having one or more triple carbon-carbon bonds and having n to m carbons. Alkynyls can be straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. In various aspects, the alkynyl moiety contains 2 to 6, 2 to 4, or 2 to 3 carbon atoms. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, cyano, silyl, sulfo-oxo, sulfonyl, sulfone, sulfoxide, thiol, or phosphonyl, as described below. It is understood that alkynyl groups can be used as a linking group, in such aspects, the alkynyl group also includes divalent alkynylene groups. The term alkynyl also includes alkynyls having multiple substitutions.

As used herein, the term “Cₙ-Cₘ alkylene,” employed alone or in combination with other terms, refers to a divalent alkyl linking group having n to m carbons. Examples of alkylene groups include but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like. In various aspects, the alkylene moiety contains 2 to 6, 2 to 4, 2 to 3, 1 to 6, 1 to 4, or 1 to 2 carbon atoms.

As used herein, the term “Cₙ-Cₘ alkoxy,” employed alone or in combination with other terms, refers to a group of formula —O-alkyl, wherein the alkyl group has n to m carbons. In other words, the term alkoxy, as used herein, is an alkyl group bound through a single, terminal ether linkage; that is, an “alkoxy” group can be defined as a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy. In other aspects, an example of alkoxy groups includes methoxy, ethoxy, propoxy (e.g., w-propoxy and isopropoxy), teri-butoxy, and the like. In various aspects, the alkyl group has 1 to 6, 1 to 4, or 1 to 3 carbon atoms.

The term “cyclic group” is used herein to refer to either aryl groups or non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

As used herein, “aryl” refers to a radical of a monocyclic or polycyclic (e.g., bicyclic or tricyclic) 4n+2 aromatic ring system (e.g., having 6, 10, or 14 it electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more cycloalkyl or heterocycle groups wherein the radical or point of attachment is on the aryl ring, and in such instances, the number of carbon atoms continues to designate the number of carbon atoms in the aryl ring system. The one or more fused cycloalkyl or heterocycle groups can be 4 to 7-member saturated or partially unsaturated cycloalkyl or heterocycle groups. Substituted aryls can also be generally referred to as aryls.

“Arylalkyl” refers to either an alkyl group as defined herein substituted with an aryl group as defined herein or to an aryl group as defined herein substituted with an alkyl group as defined herein.

The term “heterocycle” denotes saturated and partially saturated heteroatom-containing ring radicals wherein there are 1, 2, 3, or 4 heteroatoms independently selected from nitrogen, sulfur, boron, silicone, and oxygen. Heterocyclic rings may comprise monocyclic 3-10 membered rings, as well as 5-16 membered bicyclic ring systems (which can include bridged, fused, and spiro-fused bicyclic ring systems). It does not include rings containing—O—O—, —O—S—or —S—S-portions. Examples of saturated heterocycle groups include saturated 3- to 6-membered heteromonocyclic groups containing 1 to 4 nitrogen atoms [e.g., pyrrolidinyl, imidazolidinyl, piperidinyl, pyrrolinyl, piperazinyl]; saturated 3 to a 6-membered heteromonocyclic group containing 1 to 2 oxygen atoms and 1 to 3 nitrogen atoms [e.g., morpholinyl]; saturated 3 to 6-membered heteromonocyclic group containing 1 to 2 sulfur atoms and 1 to 3 nitrogen atoms [e.g., thiazolidinyl]. Examples of partially saturated heterocycle radicals include but are not limited to dihydrothienyl, dihydropyranyl, dihydrofuryl, and dihydrothiazolyl. Examples of partially saturated and saturated heterocycle groups include but are not limited to pyrrolidinyl, imidazolidinyl, piperidinyl, pyrrolinyl, pyrazolidinyl, piperazinyl, morpholinyl, tetrahydropyranyl, thiazolidinyl, dihydrothienyl, 2,3-dihydro-benzo[1,4]dioxanyl, indolinyl, isoindolinyl, dihydrobenzothienyl, dihydrobenzofuryl, isochromanyl, chromanyl, 1,2-dihydroquinolyl, 1,2, 3, 4-tetrahydro-isoquinolyl, 1,2,3,4-tetrahydro-quinolyl, 2, 3, 4, 4a, 9,9a-hexahydro-IH-3-aza-fluorenyl, 5,6,7-trihydro-1, 2, 4-triazolo[3,4-a]isoquinolyl, 3,4-dihydro-2H-benzo[1,4]oxazinyl, benzo[1,4]dioxanyl, 2,3-dihydro-IH—I λ′-benzo[d]isothiazol-6-yl, dihydropyranyl, dihydrofuryl, and dihydrothiazolyl.

“Heterocycle” also includes groups wherein the heterocyclic radical is fused/condensed with an aryl or carbocycle radical, wherein the point of attachment is the heterocycle ring. “Heterocycle” also includes groups wherein the heterocyclic radical is substituted with an oxo group (i.e.

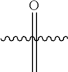 [SMILES: *=O]

). For example, a partially unsaturated condensed heterocyclic group containing 1 to 5 nitrogen atoms, for example, indoline or isoindoline; a partially unsaturated condensed heterocyclic group containing 1 to 2 oxygen atoms and 1 to 3 nitrogen atoms; a partially unsaturated condensed heterocyclic group containing 1 to 2 sulfur atoms and 1 to 3 nitrogen atoms; and a saturated condensed heterocyclic group containing 1 to 2 oxygen or sulfur atoms.

The term “heterocycle” also includes “bicyclic heterocycle.” The term “bicyclic heterocycle” denotes a heterocycle as defined herein wherein there is one bridged, fused, or spirocyclic portion of the heterocycle. The bridged, fused, or spirocyclic portion of the heterocycle can be a carbocycle, heterocycle, or aryl group as long as a stable molecule result. Unless excluded by context, the term “heterocycle” includes bicyclic heterocycles. Bicyclic heterocycle includes groups wherein the fused heterocycle is substituted with an oxo group.

“Heterocyclealkyl” refers to either an alkyl group as defined herein substituted with a heterocycle group as defined herein or to a heterocycle group as defined herein substituted with an alkyl group as defined herein.

The term “heteroaryl” denotes stable aromatic ring systems that contain 1, 2, 3, or 4 heteroatoms independently selected from O, N, and S, wherein the ring nitrogen and sulfur atom(s) are optionally oxidized, and the nitrogen atom(s) are optionally quartemized. Examples include but are not limited to, unsaturated 5 to 6 membered heteromonocyclyl groups containing 1 to 4 nitrogen atoms, such as pyrrolyl, imidazolyl, pyrazolyl, 2-pyridyl, 3-pyridyl, 4-pyridyl, pyrimidyl, pyrazinyl, pyridazinyl, triazolyl[e.g., 4H-1,2,4-triazolyl, H4-1,2,3-triazolyl, 2H-1,2,3-triazolyl]; unsaturated 5- to 6-membered heteromonocyclic groups containing an oxygen atom, for example, pyranyl, 2-furyl, 3-furyl, etc.; unsaturated 5 to 6-membered heteromonocyclic groups containing a sulfur atom, for example, 2-thienyl, 3-thienyl, etc.; unsaturated 5- to 6-membered heteromonocyclic groups containing 1 to 2 oxygen atoms and 1 to 3 nitrogen atoms, for example, oxazolyl, isoxazolyl, oxadiazolyl [e.g., 1,2,4-oxadiazolyl, 1,3,4-oxadiazolyl, 1,2,5-oxadiazolyl]; unsaturated 5 to 6-membered heteromonocyclic groups containing 1 to 2 sulfur atoms and 1 to 3 nitrogen atoms, for example, thiazolyl, thiadiazolyl [e.g., 1,2,4-thiadiazolyl, 1,3,4-thiadiazolyl, 1,2,5-thiadiazolyl], In certain embodiments the “heteroaryl” group is a 8, 9, or 10 membered bicyclic ring system. Examples of 8, 9, or 10 membered bicyclic heteroaryl groups include benzofurazanyl, benzothiophenyl, benzothiazolyl, benzoxazolyl, quinazolinyl, quinoxalinyl, naphthyridinyl, quinolinyl, isoquinolinyl, benzofuranyl, indolyl, indazolyl, and benzotri azolyl.

“Heteroaryl alkyl” refers to either an alkyl group as defined herein substituted with a heteroaryl group as defined herein or to a heteroaryl group as defined herein substituted with an alkyl group as defined herein.

As used herein, “carbocyclic,” “carbocycle,” or “cycloalkyl” includes a saturated or partially unsaturated (i.e., not aromatic) group containing all carbon ring atoms and from 3 to 14 ring carbon atoms (“C₃₋₁₄ cycloalkyl”) and zero heteroatoms in the non-aromatic ring system. In some embodiments, a cycloalkyl group has 3 to 10 ring carbon atoms (“C3-10 cycloalkyl”). In some embodiments, a cycloalkyl group has 3 to 9 ring carbon atoms (“C3-9 cycloalkyl”). In some embodiments, a cycloalkyl group has 3 to 8-ring carbon atoms (“C3-8 cycloalkyl”). In some embodiments, a cycloalkyl group has 3 to 7-ring carbon atoms (“C3-7 cycloalkyl”). In some embodiments, a cycloalkyl group has 3 to 6-ring carbon atoms (“C3-6 cycloalkyl”). In some embodiments, a cycloalkyl group has 4 to 6-ring carbon atoms (“C4-6 cycloalkyl”). In some embodiments, a cycloalkyl group has 5 to 6-ring carbon atoms (“C5-6 cycloalkyl”). In some embodiments, a cycloalkyl group has 5 to 10 ring carbon atoms (“C5-10 cycloalkyl”). Exemplary C3-6 cycloalkyl groups include, without limitation, cyclopropyl (C3), cyclopropenyl (C3), cyclobutyl (C4), cyclobutenyl (C4), cyclopentyl (C5), cyclopentenyl (C5), cyclohexyl (C6), cyclohexenyl (C6), cyclohexadienyl (C7), and the like. Exemplary C3-8 cycloalkyl groups include, without limitation, the aforementioned C3-6 cycloalkyl groups as well as cycloheptyl (C7) and cycloheptenyl (C7), cycloheptadienyl (C7), cycloheptatrienyl (C7), cyclooctyl (C8), cyclooctenyl (C8), and the like. Exemplary C3-10 cycloalkyl groups include without limitation, the aforementioned C3-8 cycloalkyl groups as well as cyclononyl (C9) and cyclononenyl (C9), cyclodecyl (C10), cyclodecenyl (C10), and the like. As the foregoing examples illustrate, in certain embodiments, the cycloalkyl group can be saturated or can contain one or more carbon-carbon double bonds. The term “cycloalkyl” also includes ring systems wherein the cycloalkyl ring, as defined above, is fused with one heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes ring systems wherein the cycloalkyl ring, as defined above, has a spirocyclic heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes bicyclic or polycyclic fused, bridged, or spiro ring systems that contain from 5 to 14 carbon atoms and zero heteroatoms in the non-aromatic ring system.

The term “bicycle” refers to a ring system wherein two rings are fused together, and each ring is independently selected from carbocycle, heterocycle, aryl, and heteroaryl.

The terms “amine” or “amino” as used herein are represented by the formula —NR¹R², where R¹ and R² can each be substitution groups as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is-C(O)NR¹R².

The term “anhydride” as used herein is represented by the formula Z¹C(O)OC(O)Z², where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride,” as used herein, is represented by the formula:

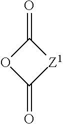

where Z¹ can be an alkyl, alkenyl, alkynyl, aryl, heteroaryl, cycloalkyl, cycloalkenyl, heterocycloalkyl, or heterocycloalkenyl group described above. The term “azide,” as used herein, is represented by the formula —N═N═N.

The term “aldehyde,” as used herein, is represented by the formula —C(O) H. Throughout this specification, “C(O)” or “CO” is a shorthand notation for C═O, which is also referred to herein as a “carbonyl.”

The term “carboxylic acid,” as used herein, is represented by the formula —C(O)OH. A “carboxylate” or “carboxyl” group, as used herein, is represented by the formula —C(O)O″.

The term “ester” as used herein is represented by the formula —OC(O)R¹ or —C(O)OR¹, where R¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula R¹OR², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three-atom ring and can be represented by the formula:

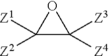

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above.

The term “ketone” as used herein is represented by the formula R¹C(O)R², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide,” “halogen,” or “halo,” as used herein, refers to fluorine, chlorine, bromine, and iodine.

The term “hydroxyl,” as used herein, is represented by the formula —OH.

The term “nitro,” as used herein, is represented by the formula —NO₂.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide,” as used herein, comprises the formula —S—.

As used herein, the term “thio” refers to a group of formulas —SH.

As used herein, the term “Cₙ-Cₘ alkylthio” refers to a group of formula —S-alkyl, wherein the alkyl group has n to m carbon atoms. In various aspects, the alkyl group has 1 to 6, 1 to 4, or 1 to 3 carbon atoms.

As used herein, the term “Cₙ-Cₘ alkylsulfonyl” refers to a group of formula —S(O)-alkyl, wherein the alkyl group has n to m carbon atoms. In various aspects, the alkyl group has 1 to 6, 1 to 4, or 1 to 3 carbon atoms.

As used herein, the term “Cₙ-Cₘ alkylsulfonyl” refers to a group of formula —S(O)₂-alkyl, wherein the alkyl group has n to m carbon atoms. In various aspects, the alkyl group has 1 to 6, 1 to 4, or 1 to 3 carbon atoms.

As used herein, the term “carbamyl” refers to a group of formula —C(O)NH₂.

As used herein, the term “carbonyl,” employed alone or in combination with other terms, refers to a-C(═O)— group, which may also be written as C(O).

As used herein, the term “carboxy” refers to a group of formula —C(O)OH.

As used herein, “halogen” refers to F, Cl, Br, or I.

The term “sulfonylamino” or “sulfonamide,” as used herein, is represented by the formula —S(O)₂NH—.

“R¹,” “R²,” “R³,” “R”,” etc., where n is some integer, as used herein, can independently possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within the second group, or alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated contrary, a formula with chemical bonds shown only as solid lines and not as wedges or dashed lines contemplates each possible stereoisomer or a mixture of stereoisomer (e.g., each enantiomer, each diastereomer, each meso compound, a racemic mixture, or scalemic mixture).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the terms “substantially identical reference composition” and “substantially identical reference article” refer to a reference composition or article comprising substantially identical components in the absence of an inventive component. In another exemplary aspect, the term “substantially,” in, for example, the context “substantially identical reference composition” or “substantially identical reference article,” refers to a reference composition or an article comprising substantially identical components and wherein an inventive component is absent or is substituted with a common in the art component.

By “reduce” or other forms of the word, such as “reducing” or “reduction,” is meant lowering of an event or characteristic (e.g., released volatiles in produced). It is understood that this is typically in relation to some standard or expected value; in other words, it is relative, but it is not always necessary for the standard or relative value to be referred to. For example, “reduces CO₂” means reducing the amount of CO₂ produced relative to a standard or a control, such as cement production without the pretreatment of CO₂. As used herein, the term “reduce” can include complete removal. In the disclosed method, a reduction can refer to a 10%, 20%, 30%, 40%, 50%, 60%, 70%, 80%, 90%, or 100% decrease as compared to the standard or a control. It is understood that the terms “sequester,” “capture,” “remove,” and “separation” are used synonymously with the term “reduce.”

By “contact” or other forms of the word, such as “contacted” or “contacting,” is meant to add, combine, or mix two or more compounds, compositions, or materials under appropriate conditions to produce a desired product or effect (e.g., to reduce or eliminate a particular characteristic or event such as CO₂ reduction). The term “react” is sometimes used when “contacting” results in a chemical reaction.

A calcium-rich cementitious material is meant to refer to a compound that has at least 1% of calcium by weight, which upon contact with water, forms concrete. Some examples of calcium-rich cementitious materials include slaked lime, fly ash, metakaolin, cement kiln dust, blended ordinary Portland cement-based cements, ground granulated blast-furnace slag, limestone fines, or any combinations of multiple calcium-rich cementitious materials.

A carbon-dioxide-rich gas is meant to refer to a gas that has at least 1 mol % of carbon dioxide. Some examples of a carbon-dioxide gas include pure carbon dioxide or post-combustion flue gas. Atmospheric air is not included in the definition of a carbon-dioxide-rich gas.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### COMPOSITIONS

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components A, B, and C are disclosed, and a class of components D, E, and F and an example of a combination composition A-D are disclosed, then even if each is not individually recited, each is individually and collectively contemplated. Thus, in this example, each of the combinations A-E, A-F, B-D, B-E, B—F, C-D, C-E, and C—F are specifically contemplated and should be considered disclosed from the disclosure of A, B, and C; D, E, and F; and the example combination A-D. Likewise, any subset or combination of these is also specifically contemplated and disclosed. Thus, for example, the sub-group of A-E, B—F, and C-E are specifically contemplated and should be considered disclosed from disclosure of A, B, and C; D, E, and F; and the example combination A-D. This concept applies to all aspects of this disclosure, including, but not limited to, steps in methods of making and using the disclosed compositions. Thus, if there are a variety of additional steps that can be performed, it is understood that each of these additional steps can be performed with any specific aspect or combination of aspects of the disclosed methods, and that each such combination is specifically contemplated and should be considered disclosed.

In one aspect disclosed herein is a composition comprising a) about 80 wt % to about 99 wt % of a cementitious material; b) about 0.05 wt % to about 3 wt % of a water-soluble organic compound and/or salts thereof; and c) about 1 wt % to about 20 wt % of carbon dioxide. In such exemplary and unlimiting aspects, the cementitious material can be present in an amount of about 80 wt % to about 99 wt %, including exemplary values of about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, and about 97 wt % of the composition. In still further aspects, the composition can comprise about 0.05 wt % to about 3 wt % of a water-soluble organic compound and/or salts thereof, including exemplary values of about 0.1 wt %, about 0.5 wt %, about 1 wt %, about 1.2 wt %, about 1.5 wt %, about 1.7 wt %, about 2.0 wt %, about 2.2 wt %, about 2.5 wt %, and about 2.7 wt % of the composition. In yet still further aspects, the composition can comprise about 1 wt % to about 20 wt % of carbon dioxide, including exemplary values of about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, and about 19 wt % of the composition.

In still further aspects, any known in the art cementitious materials suitable for the desired application can be used. In some aspects, the cementitious material can comprise Portland cement, calcium aluminate cement, calcium silicate, magnesium silicate, calcium phosphate cement, calcium aluminate sulfonate cement, fly ash, silica fume, slaked lime, cement kiln dust, limestone fines, ground granulated blast furnace slag, recycled cement mixtures, recycled concrete mixtures, an industrial waste stream comprising at least one of calcium or magnesium, cement waste, and combinations of thereof. In yet still further aspects, at least one of the cementitious materials present in the composition is calcium-rich material. In yet still further aspects, at least some amount of the cementitious material present in the compositions is sourced from recycled cement, recycled concrete, industrial waste stream, cement waste, concrete waste, or any combination thereof. In yet still further aspects, at least about 10 wt %, at least about 20 wt %, at least about 30 wt %, at least about 40 wt %, at least about 50 wt %, at least about 60 wt %, at least about 70 wt %, at least about 80 wt %, or at least about 90 wt % of the cementitious material present in the compositions is sourced from recycled cement, recycled concrete, industrial waste stream, cement waste, concrete waste, or any combination thereof, or from any other source different from Portland cement.

In certain aspects, the water-soluble organic compound and/or salts thereof comprise at least one oxygen containing functional group along a main chain or a branched chain. In yet other aspects, the at least one oxygen containing functional group is-OH or —COOH. In still further aspects, the water-soluble organic compounds and/or salts thereof are bio-resourced.

In still further aspects, the water-soluble organic compound and/or salts thereof comprise at least one X functional group along a main chain or a branched chain of the compound. In certain aspects, X can be selected from —OR¹, —C(O)OR², —C(O)R³, —N(R⁴)(R⁵), —N(R⁶)C(O)R⁷, —CN, —I, —Br, —Cl, —F, —SR⁸, —C(O)—S—, —O—C(S)—S—, —N(R⁹)—C(S)—S—, —NO₂, or any combination thereof, wherein R¹—R⁹ is, each, independently selected from hydrogen, C₁₋₁₂ alkyl, C₁₋₁₂ alkoxy, C₁₋₁₂ heteroalkyl, —(C₀₋₅ alkyl) (C₆₋₁₄ aryl), —(C₀₋₅ alkyl) (C₁₋₁₃ heteroaryl), —(C₀₋₅ alkyl) (C₆₋₁₄ aryloxy), —(C₀₋₅ alkyl) (C₃₋₁₀ cycloalkyl), —(C₀₋₅ alkyl) (C₃₋₁₀ heterocycloalkyl), —(C₀₋₅ alkyl) (C₃₋₁₀ cycloalkenyl), —(C₀₋₅ alkyl) (C₃₋₁₀ heterocycloalkenyl), halide, amine; wherein R¹—R⁹ each is independently and optionally substituted with one or more of C₁₋₁₂ alkyl, C₁₋₁₂ alkoxy, C₁₋₁₂ heteroalkyl, —(C₀₋₅ alkyl) (C₆₋₁₄ aryl), —(C₀₋₅ alkyl) (C₁₋₁₃ heteroaryl), —(C₀₋₅ alkyl) (C₆₋₁₄ aryloxy), —(C₀₋₅ alkyl) (C₃₋₁₀ cycloalkyl), —(C₀₋₅ alkyl) (C₃₋₁₀ heterocycloalkyl), —(C₀₋₅ alkyl) (C₃₋₁₀ cycloalkenyl), —(C₀₋₅ alkyl) (C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl.

In yet still further aspects, R¹—R⁹ is hydrogen or C₁₋₁₂ alkyl. In yet still further aspects, X can be selected from —OH, —COOH, —NH₂, —SH, —O—CH₃, —I, —Br, —Cl, —F, or any combination thereof.

In still further aspects, the water-soluble organic compound and/or salts thereof are configured to retard the hydration of the cementitious material. In yet still further aspects, the water-soluble organic compound and/or salts thereof are configured to mediate the formation of carbonates. In yet still further aspects, the water-soluble organic compound and/or salts thereof are configured to disperse the precipitates. In still further aspects, the water-soluble organic compound and/or salts thereof are configured to retard the hydration of the cementitious material, mediate the formation of carbonates, and disperse the precipitates.

In still further aspects, the water-soluble organic compound and/or salts thereof comprises citric acid and its derivatives, ascorbic acid and its derivatives, tannic acid and its derivatives, allic acid and its derivatives, ellagic acid and its derivatives, coumaric acid and its derivatives, cinnamic acid and its derivatives, hydroxycinnamic acid, and its derivatives, hexahydroxydiphenic acid, and its derivatives, quercetin and its derivatives, kaempferol, and its derivatives, catechin and its derivatives, anthocyanin and its derivatives, simple and complex sugars, and their derivatives, amino acids and their derivatives, or any combination thereof.

In still further aspects, the water-soluble organic compound and/or salts thereof has a molecular weight of about 50 to about 9,000 g/mol, including exemplary values of about 100 g/mol, about 150 g/mol, about 200 g/mol, about 500 g/mol, about 1,000 g/mol, about 2,000 g/mol, about 3,000 g/mol, about 4,000 g/mol, about 5,000 g/mol, about 6,000 g/mol, about 7,000 g/mol, and about 8,000 g/mol.

In yet still further aspects, the cementitious material is hydraulic.

In still further aspects, the composition can further comprise additives. In such aspects, the additives can comprise any material commonly used in cement manufacturing. In still further aspects, the composition can comprise a filler, an aggregate material, an extra hydraulic cementitious material, or a combination thereof. In such exemplary and unlimiting aspects, the extra hydraulic cementitious materials can comprise Portland cement, calcium aluminate cement, calcium phosphate cement, calcium aluminate sulfonate cement, fly ash, silica fume, cement kiln dust, limestone fines, ground granulated blast furnace slag, recycled cement mixtures, recycled concrete mixtures, concrete waste, cement waste, an industrial waste stream comprising at least one of calcium or magnesium, cement waste, and combinations of thereof.

In still further aspects, the filler can comprise Quartz powder, limestone powder, basalt powder, marble powder, waste glass powder, fly ash, stone dust, silica fume, blast furnace slag, or any combination thereof and the like.

In still further aspects, the aggregate material comprises silica sand, natural sand, crushed stone, gravel, ground glass, recycled foundry sand, bottom ash, slag, or any combination thereof. It is understood that aggregates can have any desirable size. For example, in some aspects, the aggregates can be coarse aggregates having a size larger than about 4.75 mm, larger than about 5.0 mm, larger than about 5.5 mm, larger than about 6 mm, larger than about 6.5 mm, larger than about 7.0 mm, larger than about 7.5 mm, larger than about 8 mm, larger than about 8.5 mm, larger than about 9.0 mm, larger than about 9.5 mm, or larger than about 10.0 mm. In yet other aspects, the aggregates can be fine aggregates. In such aspects, the fine aggregates can have a size smaller than about 4.75 mm, smaller than about 4.5 mm, smaller than about 4.0 mm, smaller than about 3.5 mm, smaller than about 3.0 mm, smaller than about 2.5 mm, smaller than about 2.0 mm, smaller than about 1.5 mm, smaller than about 1.0 mm, smaller than about 0.5 mm, or smaller than about 0.1 mm.

In still further aspects, disclosed herein are articles comprising the disclosed herein composition. In certain aspects, the article comprises a concrete, a tile, a brick, a paver, a panel, a synthetic stone, or any combination thereof. In yet still further aspects, the article exhibits a compressive strength of at least about 10%, at least about 12%, at least about 15%, at least about 17%, at least about 20%, at least about 22%, at least about 25%, at least about 27%, at least about 30%, at least about 32%, at least about 35%, at least about 37%, at least about 40%, at least about 42%, at least about 45%, at least about 47%, or at least about 50% higher when compared with a substantially identical reference article comprising a substantially identical composition in the absence of the water-soluble organic compound and/or salts thereof.

In other aspects, the articles disclosed herein exhibit a carbon footprint that is at least about 10%, at least about 12%, at least about 15%, at least about 17%, at least about 20%, at least about 22%, at least about 25%, at least about 27%, at least about 30%, at least about 32%, at least about 35%, at least about 37%, at least about 40%, at least about 42%, at least about 45%, at least about 47%, or at least about 50% lower when compared with a substantially identical reference article comprising a substantially identical composition in the absence of the water-soluble organic compound and/or salts thereof.

### METHODS

Also disclosed herein are methods for preparing the disclosed above compositions. In such aspects, the methods comprise a) contacting a first cementitious material with a water-soluble organic compound and/or salts thereof to form a first slurry; b) contacting the first slurry with a carbon-dioxide-rich gas to form a second slurry; and c) adding second cementitious material to the second slurry. It is understood that the step of contacting can comprise any known in the art methods. The contacting can be achieved by simply mixing the first cementitious material with a water-soluble organic compound and/or salts thereof. For example, the contacting can be done by first blending the dry components and then adding an aqueous solution to form a slurry. In yet other aspects, the water-soluble organic compound and/or salts thereof can be first dissolved in water and then mixed with the cementitious material to form a slurry. In yet still further aspects, the cementitious material can be first mixed with water and then mixed with the water-soluble organic compound and/or salts thereof to form the first slurry. In still further aspects, the water-soluble organic compound and/or salts thereof can be present as a solution.

It is further understood that step a) can be done under ambient conditions. In yet other aspects, step a) can be done at elevated temperatures. For example, and without limitations, the first step can be done at a temperature of about 20° C. to about less than 100° C., including exemplary values of about 25° C., about 30° C., about 35° C., about 40° C., about 45° C., about 50° C., about 55° C., about 60° C., about 65° C., and about 70° C.

In yet further aspects, the temperature is in a range of about 30° C. to about 70° C., including exemplary values of about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 57° C., about 58° C., about 59° C., about 60° C., about 61° C., about 62° C., about 63° C., about 64° C., and about 65° C.

In still further aspects, step a) can be immediately followed by step b). Yet, in other aspects, the formed first slurry is let to stay for about 5 min to about 5 hours, including exemplary values of about 10 min, about 30 min, about 45 min, about 1 h, about 1.5 h, about 2 h, about 2.5 h, about 3 h, about 3.5 h, about 4 h, and about 4.5 h to allow a full reaction between the first cementitious material with the water-soluble organic compound and/or salts thereof.

In still further aspects, the first slurry can have a pH greater than about 7, greater than about 7.5, greater than about 8, greater than about 8.5, greater than about 9, greater than about 9.5, greater than about 10, greater than about 10.5, greater than about 11, greater than about 11.5, greater than about 12, greater than about 12.5, greater than about 13, or greater than about 13.5.

In still further aspects, the first cementitious material comprises Portland cement, calcium aluminate cement, calcium silicate, magnesium silicate, calcium phosphate cement, calcium aluminate sulfonate cement, fly ash, silica fume, slaked lime, cement kiln dust, limestone fines, ground granulated blast furnace slag, recycled cement mixtures, recycled concrete mixtures, concrete waste, cement waste, an industrial waste stream comprising at least one of calcium or magnesium, cement waste, and combinations of thereof. In yet still further aspects, the second cementitious material comprises Portland cement.

In still further aspects, the method disclosed herein produces the composition comprising a) a total of about 80 wt % to about 99 wt % of a cementitious material comprising both the first and second cementitious materials; b) about 0.05 wt % to about 3 wt % of a water-soluble organic compound and/or salts thereof; and c) about 1 wt % to about 20 wt % of carbon dioxide. In such exemplary and unlimiting aspects, the cementitious material can be present in an amount of about 80 wt % to about 99 wt %, including exemplary values of about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, and about 97 wt % of the composition. In still further aspects, the composition can comprise about 0.05 wt % to about 3 wt % of a water-soluble organic compound and/or salts thereof, including exemplary values of about 0.1 wt %, about 0.5 wt %, about 1 wt %, about 1.2 wt %, about 1.5 wt %, about 1.7 wt %, about 2.0 wt %, about 2.2 wt %, about 2.5 wt %, and about 2.7 wt % of the composition. In yet still further aspects, the composition can comprise about 1 wt % to about 20 wt % of carbon dioxide, including exemplary values of about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, and about 19 wt % of the composition.

In still further aspects, any of the disclosed above water-soluble organic compounds and/or salts thereof can be used in the disclosed herein methods.

In still further aspects, the second slurry can comprise a plurality of substantially uniformly dispersed nanoparticles comprising calcium carbonate. In such aspects, the nanoparticles can have a size of about 5 nm to about 500 nm, including exemplary values of about 10 nm, about 20 nm, about 30 nm, about 40 nm, about 50 nm, about 60 nm, about 70 nm, about 80 nm, about 90 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, and about 475 nm.

In still further aspects, the calcium carbonate present in the nanoparticles is polymorphous.

In yet still further aspects, the methods can comprise a step of adding fillers, aggregates, an extra hydraulic cementitious material, or a combination thereof. Any of the disclosed above fillers, aggregates, and extra hydraulic cementitious materials can be utilized.

Aggregates and other admixtures can be added as fillers or to concrete mixtures to modify the hardened concrete, such as the workability or compressive strength. Aggregates may be added to concrete mixtures to influence the hardness or the workability of the concrete. Some examples of aggregates are sand, gravel, crushed stone, or any of the disclosed above materials. Admixtures may be added to concrete mixtures to improve stability or to ensure the quality of concrete during mixing, transporting, placing, and curing. Some examples of admixtures include pigments or chemical admixtures.

In still further aspects, the carbon-dioxide-rich gas can be any known in the art gas comprising carbon dioxide and suitable for the desired application. In certain aspects, carbon-dioxide-rich gas is from post-combustion flue gas, and the carbon-dioxide-rich gas is a by-product of the manufacture of cement or a combination thereof. In still further aspects, the carbon-dioxide-rich gas can be a by-product of any manufacturing process that produces carbon dioxide waste. It is understood that the step of contacting with carbon-dioxide-rich gas comprises bubbling the gas through the first slurry to form the second slurry. It is also understood that the step of bubbling can be done at room temperature or elevated temperature of about 30° C. to about 70° C., including exemplary values of about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 57° C., about 58° C., about 59° C., about 60° C., about 61° C., about 62° C., about 63° C., about 64° C., and about 65° C.

In still further aspects, the CO₂ is added until the pH of the slurry is reduced substantially to about pH 7.

In still further aspects, the CO₂ can be added through a gas bubbler, dissolution, adsorption, absorption, or a mixture thereof. Carbon dioxide dissolved in the slurry can react with calcium ions in the slurry to form a mixture of calcium carbonate and calcium bicarbonate. The CO₂ can be stored in the calcium carbonate and calcium bicarbonate compounds.

In still further aspects, the method can further comprise a step of forming an article. Any of the disclosed herein articles can be formed. For example, and without limitations, the formed article can comprise a concrete, a tile, a brick, a paver, a panel, a synthetic stone, or any combination thereof.

In other aspects, the article formed by the disclosed methods exhibits a compressive strength of at least about 10%, at least about 12%, at least about 15%, at least about 17%, at least about 20%, at least about 22%, at least about 25%, at least about 27%, at least about 30%, at least about 32%, at least about 35%, at least about 37%, at least about 40%, at least about 42%, at least about 45%, at least about 47%, or at least about 50% higher when compared with a substantially identical reference article comprising a substantially identical composition in the absence of the water-soluble organic compound and/or salts thereof.

In other aspects, the article formed by the disclosed methods exhibits a carbon footprint that is at least about 10%, at least about 12%, at least about 15%, at least about 17%, at least about 20%, at least about 22%, at least about 25%, at least about 27%, at least about 30%, at least about 32%, at least about 35%, at least about 37%, at least about 40%, at least about 42%, at least about 45%, at least about 47%, or at least about 50% lower when compared with a substantially identical reference article comprising a substantially identical composition in the absence of the water-soluble organic compound and/or salts thereof.

Also disclosed herein is a method comprising: a) contacting a first cementitious material with a water-soluble organic compound and/or salts thereof to form a first slurry; b) contacting a first slurry with a carbon-dioxide-rich gas to form a second slurry; wherein the second slurry comprises carbonates; and c) drying and grinding the second slurry into fine powders with a size smaller than about 0.15 mm. In such methods, any of the disclosed above first and second cementitious materials can be used. In still further aspects, any of the disclosed above water-soluble organic compounds and/or salts thereof can be utilized. It is also understood that step a) can be performed as described above. In still further aspects, any of the disclosed above carbon-dioxide-rich gases can be utilized, and any of the conditions disclosed above can also be applied here.

In still further aspects, the step of drying can be done by any known the art method. For example, the step of drying can be done in the oven or furnace. In still further aspects, the drying is done until the second slurry is substantially free of water and becomes the desired composition. In still further aspects, this desired composition has a water content of 0.0 wt % to about 5 wt %, including exemplary values of about 0.01 wt %, about 0.05 wt %, about 0.1 wt %, about 0.25 wt %, about 0.5 wt %, about 0.75 wt %, about 1 wt %, about 1.25 wt %, about 1.5 wt %, about 1.75 wt %, about 2 wt %, about 2.25 wt %, about 2.5 wt %, about 2.75 wt %, about 3 wt %, about 3.25 wt %, about 3.5 wt %, about 3.75 wt %, about 4 wt %, about 4.25 wt %, about 4.5 wt %, and about 4.75 wt %. In still further aspects, the composition is ground to form fine powders with sizes smaller than about 0.15 mm, smaller than about 0.1 mm, smaller than about 50 micrometers, smaller than about 10 micrometers, and smaller than about 1 micrometer, or smaller than about 500 nm.

Also disclosed herein are methods of forming a composition comprising: a) mixing a washing water with a waste concrete comprising a first cementitious material to form a diluted mixture of the waste concrete; b) removing aggregates from the mixture of the waste concrete to form a waste concrete slurry; c) contacting a waste concrete slurry with a water-soluble organic compound and/or salts thereof to form a first slurry; d) contacting the first slurry with a carbon-dioxide-rich gas to form a second slurry; and e) adding a second cementitious material to the second slurry to form the composition.

It is understood that the washing water can be collected from washing any concrete-containing vessels. In still further aspects, it is understood that the waste concrete can be any unused concrete. For example, it can be a fresh concrete that was left over from the desired project. However, any other waste concretes are also contemplated.

Still further aspects disclosed herein are also methods of making an article. In such aspects, the compositions formed by any of the disclosed herein methods are formed into the article, where the article can comprise a concrete, a tile, a brick, a paver, a panel, a synthetic stone, or any combination thereof.

In a later step, other ingredients of the concrete, including OPC, aggregates, and other admixtures, as needed depending on the particular application, can be added and mixed with the slurry produced in the first step to produce concrete.

### EXAMPLES

The following examples are set forth below to illustrate the methods and results according to the disclosed subject matter. These examples are not intended to be inclusive of all aspects of the subject matter disclosed herein but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, and the temperature is in ° C. or is at ambient temperature, and pressure is at or near atmospheric. There are numerous variations and combinations of reaction conditions, e.g., component concentrations, temperatures, pressures, and other reaction ranges and conditions, that can be used to optimize the product purity and yield obtained from the described process. Only reasonable and routine experimentation will be required to optimize such process conditions.

In some aspects, the methods disclosed herein reduce the CO₂ emission of concrete by at least 20% through enhancing the compressive strength of the concrete by using CO₂ as an admixture. CO₂ can be added into concrete during three different stages of the concrete manufacturing process: after the concrete is cast through the CO₂ curing method, during the mixing of the concrete through injecting CO₂ into the fresh concrete (used by CarbonCure), and before the mixing of concrete through bubbling CO₂ into mixing water mixed with calcium-rich mineral. Once added to concrete, CO₂ can react with calcium-rich hydration products such as calcium hydroxide (CH) or calcium silicate hydrate (C—S—H) to produce calcium carbonate and, therefore, is permanently stored in the concrete. As shown in U.S. Pat. No. 10,392,305, the content of which is incorporated herein by reference, CO₂ can be directly added into the mixing water of the concrete before the mixing through a two-step mixing process. In the first step of mixing, a slurry comprising calcium-rich mineral particles and the mixing water is produced, which is then carbonated by bubbling CO₂. Calcium carbonate precipitate and calcium bicarbonate ions are produced in the mixing water in this step. The carbonated slurry is then mixed with the rest of the ingredients to produce concrete. Since CO₂ is added to the concrete before the mixing, this method is referred to herein as the pre-carbonation method.

### Example 1

In aspects of the present disclosure, fine powders of calcium-rich waste materials can be used to partially replace OPC in the concrete. These fine powders can be such as recycled concrete fines. Fine powders of the calcium-rich mineral are used to not only absorb CO₂ but also partially replace ordinary Portland cement (OPC), the major contributor to the carbon emission of the concrete. The fine powders can be waste/demolished concretes, minerals such as magnesium and calcium silicate, and industrial waste streams containing significant quantities of available carbonation reactants, predominantly Ca and Mg oxides. All these minerals fine powders can be quickly carbonated in the pre-carbonation process. The carbonation products are calcium (magnesium) carbonate and amorphous silica gel. Both can be added to the concrete to partially replace the OPC, further reducing the carbon emission of the produced concrete.

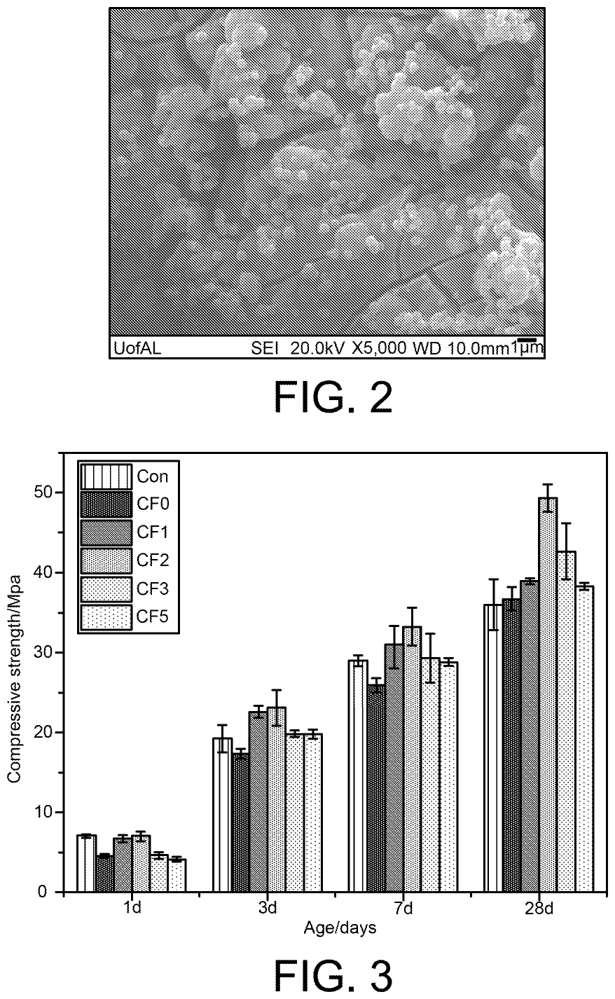

In certain aspects, the water-soluble organic compounds and/or salts thereof can be added to regulate the carbonation of the mineral in the pre-carbonation process. Any of the disclosed above water-soluble organic compounds and/or salts thereof can be utilized. In certain exemplary and unlimiting aspects, the water-soluble organic compounds and/or salts thereof can comprise plant-based organic compounds and/or salts thereof. Such compounds can be adsorbed on the produced calcium carbonate nanoparticles. The steric repulsion generated by the adsorbed of these water-soluble organic compounds and/or salts thereof inhibits the growth and agglomeration of the nanoparticles and provides better dispersion of these nanoparticles. This regulation process can generate more well-dispersed CaCO₃ nanoparticles in the carbonated slurry (FIG. 2). Once added to concrete, they function as other nanoparticles, seeding the hydration of the cement and filling small pores of the concrete. In still further aspects, the water-soluble organic compounds and/or salts thereof disclosed herein can control the polymorph of the produced CaCO₃ since more amorphous calcium carbonate (ACC) or vaterite, rather than calcite. When added to concrete, these ACC or vaterite particles will experience a dissolving-recrystallization process to form calcite, providing the extra binding ability for the concrete.

Six groups of mortar samples were manufactured. Table 1 shows the mix design of these mortar samples. In this table, the control (Con) specimen was made without using the pre-carbonation method. CF0 group was made with the pre-carbonation method. To do this, recycled concrete fines at 10% of the OPC used in the control group were mixing with water to produce a slurry. Then CO₂ is bubbled into the slurry until the pH value of the slurry is reduced to 7.0. After that, cement and sand were added into the carbonate slurry to make cement mortar the same way as the control group. CFX groups were made in the same way as the CF0 group with only one difference, the mixing water containing a water-soluble organic compound and/or salts thereof, for example, tannic acid (TA), at 0.X % of cement of the mortar. All produced mortar samples were cured in a curing room at 23° C.

The compressive strengths of the produced mortars are shown in FIG. 3. Compared with the control group, pre-carbonating recycled concrete fines to replace 10% of OPC reduces the compressive strengths of the mortar at early ages. At 28d, the compressive strength of the CF0 mortar is slightly surpasses that of the control one. Once TA is used to regulate the carbonation, the compressive strength can be significantly increased. It can be seen that CF2 has higher strength than CF1 at any ages, suggesting that 0.1% TA is not sufficient to regulate the pre-carbonation process. However, when more than 0.2% TA is added, the compressive strength of the mortar is reduced. This is because the residual TA in the pre-carbonated slurry can retard the hydration of the cement, leading to the lower compressive strength of the produced mortar. This can be further confirmed by the fact that the compressive strength of CF5 is lower than that of CF3 at all ages. At the optimal dose of 0.2%, the compressive strength of the mortar has been improved by over 30% by the proposed method, indicating the importance to control the formation of CaCO₃ precipitate with TA.

TABLE 1
Mix design of mortars

| | | Recycled | | |
|---|---|---|---|---|
| | | concrete | | |
| Specimen | Cement (g) | fines (g) | Water (g) | sand |
| Con | 34.5 | 0 | 15.5 | 50 |
| CF0 | 31.05 | 3.45 | 15.5 | 50 |
| CF1 | 31.05 | 3.45 | 15.5 | 50 |
| CF2 | 31.05 | 3.45 | 15.5 | 50 |
| CF3 | 31.05 | 3.45 | 15.5 | 50 |
| CF5 | 31.05 | 3.45 | 15.5 | 50 |

The results shown in FIG. 3 suggest that this technology has a clear-cut advantage over the existing technology: the compressive strength of the cement mortar can be significantly enhanced by our technology (over 35%) even less cement is used. In the disclosed herein method, the carbonation process is regulated by one or more of the disclosed herein water-soluble organic compounds and/or salts thereof. Without this regulation, no strength improvement can be clearly demonstrated.

Cost of this method mainly comes from the equipment needed for the pro-carbonation process and the water-soluble organic compound and/or salts thereof, as disclosed herein, needed to regulate the carbonation. No complicated system is needed to carry out the pre-carbonation process. Typically, a separate container other than the mixer is needed in this technology. In this container, the mixing water can be mixed with the calcium-rich fine powders and CO₂. This container should be closable to prevent the escape of CO₂. To accelerate the carbonation process, a mechanical stirrer should be installed inside the container to stir the slurry during the carbonation.

In this example, TA was used to regulate the carbonation. TA is the third-largest plant-based organic compound and/or salts thereof, only after cellulose and lignin. The commercially available TA can cost about $5/kg. For one cubic meter of concrete, 0.6 kg TA is needed, which adds $3/m³ to the concrete with a benefit of a 20% reduction in its carbon footprint. However, high-purity TA is not necessary for this technology. Therefore, TA can be extracted from many plant parts (and even be made from current industrial waste and by-products. In these cases, the cost of TA can be reduced by around $1/kg on an industrial scale.

Other low-cost water-soluble organic compounds and/or salts thereof, such as ascorbic acid (vitamin C) (at $3/kg), can also be used to regulate carbonation to achieve similar strength improvement. In such a case, the cost for these water-soluble organic compounds and/or salts thereof can be further reduced to $1.8/m³. Citric acid ($0.5/kg) is another low-cost option.

The benefits generated by this technology: are at least 15% savings of cement, storing 10 kg/m³ CO₂ in the concrete, and 20% improvement in the compressive strength. Considering all these benefits, the carbon footprint of the produced concrete is reduced by at least 20%.

It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

### Example 2

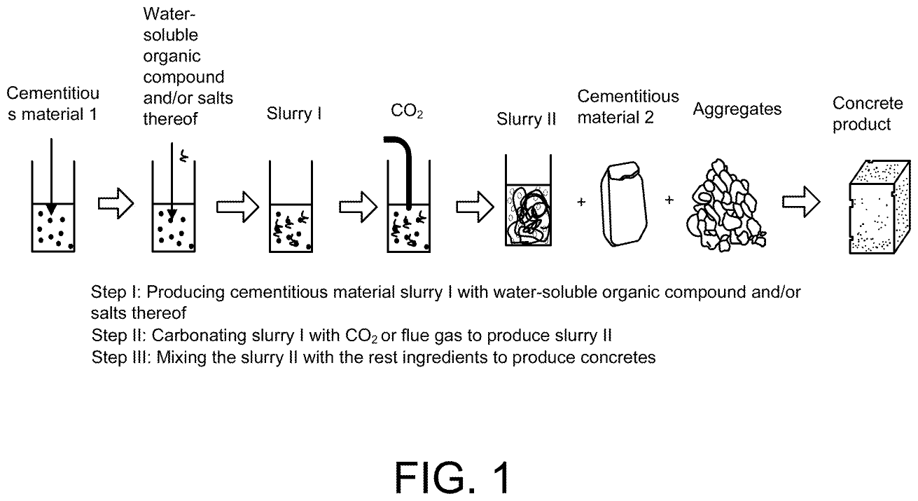

A group of cement mortars was made with the proposed method using the mix given in Table 2. These mortars were produced with the conventional method (Control group in Table 3) and the proposed method shown in FIG. 1. As shown in Table 3, the 0.3TA-50-12 Hr was made by first mixing 50% of cement with mixing water and 0.3% (by weight of the cement) tannic acid for 12 h to make slurry I, which was then carbonated by bubbling CO₂ through the slurry to make slurry II. After carbonation, slurry II was mixed with the rest 50% of the cement, all sand, to make cement mortar samples.

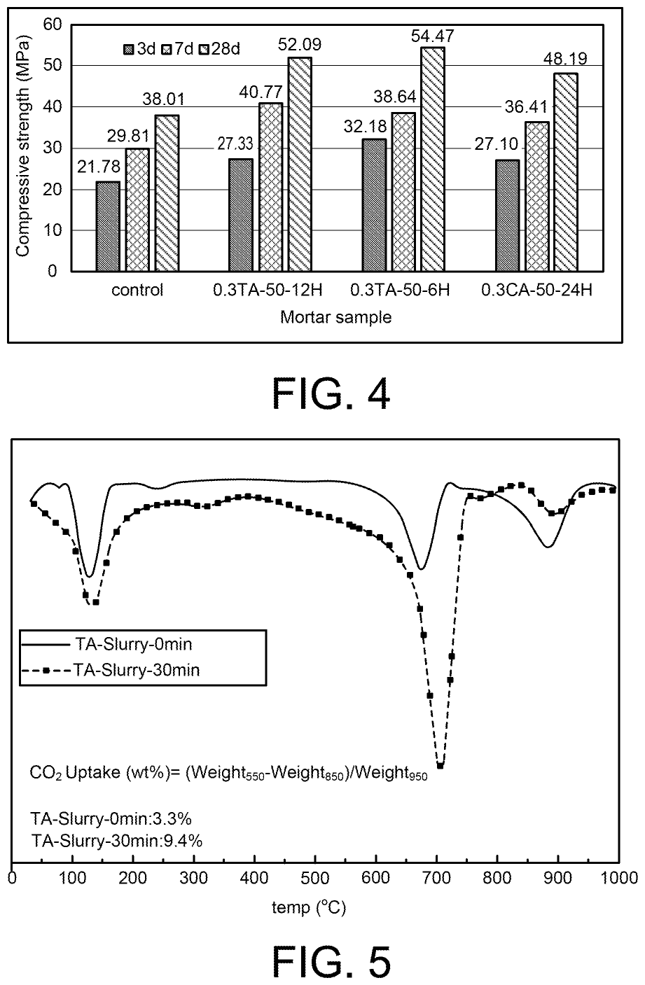

Mortar 0.3TA-50-6H was made in a similar way, with the only difference in that the slurry I was mixed for 6 h before carbonation. Mortar 0.3CA-50-24H was made by first mixing 50% of the cement with mixing water and 0.3% (by weight of the cement) citric acid for 24 h to produce slurry I. The slurry I was then carbonated to produce slurry II. The mortar was made by mixing the slurry II with the rest 50% of the cement and all sand. This suggests that returned concrete and washing water can be stored for at least 24 h before recycling into new concrete through carbonation. All mortars were cured in standard curing conditions, and their compressive strengths were measured using 2 in. X 4 in. cylinder specimens at 3d, 7d, and 28d. Results are shown in FIG. 4. It can be seen that significant strength improvement has been achieved by the proposed method. For example, the compressive strength of 0.3TA-50-12H is 45% higher than that of the control sample. The amount of CO₂ absorbed by the produced concrete can be evaluated by TGA analysis, which is shown in FIG. 5. It can be seen that the uptake of CO₂ by the cement slurry used in this example is 6.1%. Considering that half of the cement was used in the slurry, CO₂ absorbed by the cement slurry for this sample reached 3% by weight of the cement, which is one order of magnitude higher than that reached by existing methods.

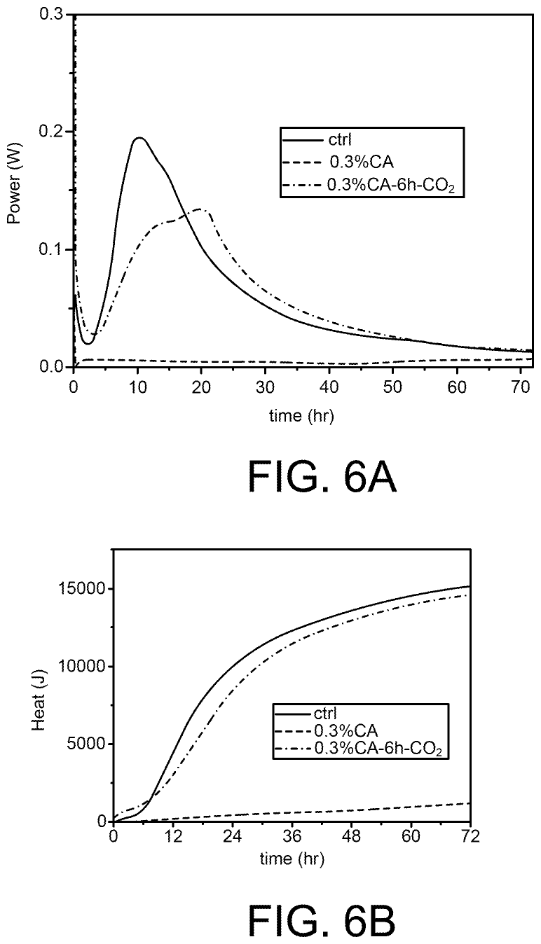

FIG. 6 shows the isothermal calorimetry result of three cement pastes with water to cement ratio=0.5. Compared with the control sample, adding 0.3% of citric acid almost completely stopped the hydration of cement for 72 h, suggesting that cement slurry produced from returned concrete can be saved for at least 72 h. After carbonating this cement paste, the hydration of the cement can be activated, and the hydration heat of this paste (0.3% CA-6 h-CO₂) almost captures that of a control sample. This is because a large amount of CaCO₃ nanoparticles were produced in the carbonated cement slurry. By seeding the hydration of cement, these nanoparticles effectively eliminated the retarding effect of citric acid.

### Example 3

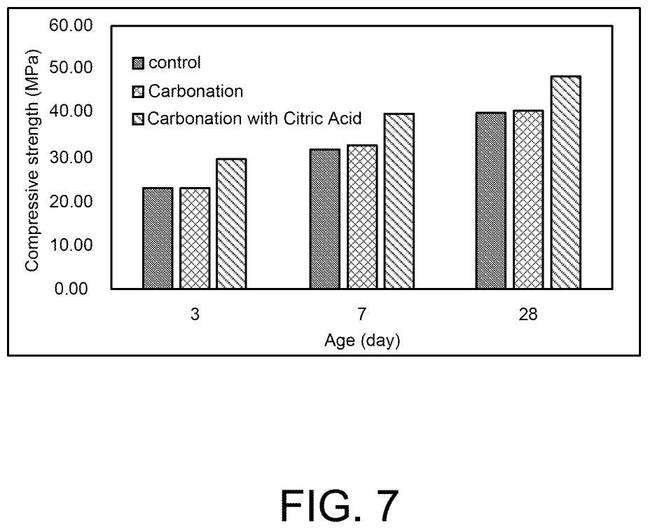

Three concrete samples were produced using the mix design shown in Table 4. The control sample was made with an existing one-step method. The Carbonation sample was produced using the two-step mixing method shown in FIG. 1. In the first step, 50% of the cement was mixed with water to produce a cement slurry, which was then carbonated and mixed with the rest ingredients of the concrete. The Carbonation with Citric Acid sample with made in a similar way as the Carbonation sample, except that 0.3% citric acid was added to the cement slurry to regulate the carbonation process. The compressive strengths of these concretes shown in FIG. 7. It can be seen that the compressive strength of the Carbonation sample is almost identical to the control sample, while significant strength improvement has been achieved by the one made with carbonating the cement slurry with citric acid. At 28 day, the compressive strength of this concrete is still 20% higher than the control one.

TABLE 2
Mix design of mortars

| ingredients | cement | sand | water |
|---|---|---|---|
| weight (g) | 1100 | 2850 | 550 |

TABLE 3
Manufacturing methods of mortar samples

| | organic | | | | |
|---|---|---|---|---|---|
| | compound | | content of | reaction | |
| | and/or salts | | cement for | duration of | |
| sample | thereof | dose | slurry I | slurry I (h) | carbonation |
| control | | 0 | 0 | 0 | N |
| 0.3TA- | tannic acid | 0.30% | 50% | 12 | Y |
| 50-12H | | | | | |
| 0.3TA- | tannic acid | 0.30% | 50% | 6 | Y |
| 50-6H | | | | | |
| 0.3CA- | citric acid | 0.30% | 0.50 | 24 | Y |
| 50-24H | | | | | |

TABLE 4
Mix design of concrete

| Ingredient | cement (lb) | Sand (lb) | Gravel (lb) | Water (lb) |
|---|---|---|---|---|
| Weight (lb) | 30 | 60 | 80 | 15 |

### Example 4

This processes disclosed herein can also be used to recycle returned fresh concrete and washing water. To this end, returned concrete is mixed with washing water so that aggregates can be easily separated and reclaimed. The resulting slurry, rich with reacted and unreacted cement clinker, can be used to replace the cement slurry in this example for carbonation.

In such examples, the washing water can be water collected from washing concrete compartments in concrete carrying vehicles, any concrete holding vessels, and the like. It is understood that a ready-mix concrete plant, on average, can generate about 5-10% waste fresh concrete. The unused for a desired purpose concrete can also be returned to the plant. In order to recycle both the washing water and the returned concrete, the washing water can be mixed with the waste fresh concrete to form a diluted waste concrete mixture. The aggregates, such as sand, gravel and the like, can then be reclaimed. The remaining cementitious slurry can then be mixed with the water-soluble organic compound and/or salts thereof to form the first slurry. The first slurry is then contacted with CO₂ to form the second slurry. The second slurry can then be mixed with the rest ingredients to produce a recycled concrete.

### EXEMPLARY ASPECTS

Example 1: A composition comprising: a) from about 80 wt % to about 99 wt % of a cementitious material; b) about 0.05 wt % to about 3 wt % of a water-soluble organic compound and/or salts thereof; and c) about 1 wt % to about 20 wt % of carbon dioxide.

Example 2: The composition of any examples herein, particularly example 1, wherein the cementitious material comprises Portland cement, calcium aluminate cement, calcium silicate, magnesium silicate, calcium phosphate cement, calcium aluminate sulfonate cement, fly ash, silica fume, slaked lime, cement kiln dust, limestone fines, ground granulated blast furnace slag, recycled cement mixtures, recycled concrete mixtures, an industrial waste stream comprising at least one of calcium or magnesium, cement waste, concrete waste, and combinations of thereof.

Example 3: The composition of any examples herein, particularly example 1 or 2, wherein the water-soluble organic compound and/or salts thereof comprise at least one oxygen containing functional group along a main chain or a branched chain.

Example 4: The composition of any examples herein, particularly example 3, wherein at least one oxygen containing functional group is-OH or —COOH.

Example 5: The composition of any examples herein, particularly examples 1-4, wherein the cementitious material is hydraulic.

Example 6: The composition of any examples herein, particularly examples 1-5, wherein the water-soluble organic compound and/or salts thereof are configured to retard hydration of the cementitious material, mediate formation of carbonates, and disperse precipitates.

Example 7: The composition of any examples herein, particularly examples 1-6, wherein the water-soluble organic compound and/or salts thereof comprise citric acid and its derivatives, ascorbic acid and its derivatives, tannic acid and its derivatives, allic acid and its derivatives, ellagic acid and its derivatives, coumaric acid and its derivatives, cinnamic acid and its derivatives, hydroxycinnamic acid, and its derivatives, hexahydroxydiphenic acid, and its derivatives, quercetin and its derivatives, kaempferol, and its derivatives, catechin and its derivatives, anthocyanin and its derivatives, simple and complex sugars, and their derivatives, amino acids and their derivatives, or any combination thereof.

Example 8: The composition of any examples herein, particularly examples 1-7, wherein the water-soluble organic compound and/or salts thereof has a molecular weight of about 50 to about 9,000 g/mol.

Example 9: The composition of any examples herein, particularly examples 1-8, wherein the composition further comprises a filler, an aggregate material, an extra hydraulic cementitious material, or a combination thereof.

Example 10: The composition of any examples herein, particularly example 9, wherein the aggregate material comprises silica sand, natural sand, crushed stone aggregates, gravel, ground glass, recycled foundry sand, bottom ash, slag, or any combination thereof.

Example 11: An article comprising the composition of any examples herein, particularly examples 1-10.

Example 12: The article of any examples herein, particularly example 11, wherein the article comprises a concrete, a tile, a brick, a paver, a panel, a synthetic stone, or any combination thereof.

Example 13: The article of any examples herein, particularly examples 11-12, wherein the article exhibits a compressive strength of at least about 10% higher when compared with a substantially identical reference article comprising a substantially identical composition in the absence of the water-soluble organic compound and/or salts thereof.

Example 14: The article of any examples herein, particularly examples 11-13, wherein the article exhibits a carbon footprint of at least about 10% lower when compared with a substantially identical reference article comprising a substantially identical composition in the absence of the water-soluble organic compound and/or salts thereof.

Example 15: A method of forming a composition comprising: a) contacting a first cementitious material with a water-soluble organic compound and/or salts thereof to form a first slurry; b) contacting the first slurry with a carbon-dioxide-rich gas to form a second slurry; and c) adding second cementitious material to the second slurry to form the composition.

Example 16: The method of any examples herein, particularly example 15, wherein the composition comprises: a) a total of about 80 wt % to about 99 wt % cementitious material comprising both the first and second cementitious materials; b) about 0.05 wt % to about 3 wt % of a water-soluble organic compound and/or salts thereof; and c) about 1 wt % to about 20 wt % of carbon dioxide.

Example 17: The method of any examples herein, particularly example 15 or 16, wherein the water-soluble organic compound and/or salts thereof is present as a solution.

Example 18: The method of any examples herein, particularly examples 15-17, wherein the first cementitious material comprises Portland cement, calcium aluminate cement, calcium silicate, magnesium silicate, calcium phosphate cement, calcium aluminate sulfonate cement, fly ash, silica fume, slaked lime, cement kiln dust, limestone fines, ground granulated blast furnace slag, recycled cement mixtures, recycled concrete mixtures, an industrial waste stream comprising at least one of calcium or magnesium, cement waste, concrete waste, and combinations of thereof.

Example 19: The method of any examples herein, particularly examples 15-18, wherein the second cementitious material comprises Portland cement.

Example 20: The method of any examples herein, particularly examples 15-19, wherein the water-soluble organic compound and/or salts thereof comprise at least one oxygen containing functional group along a main chain or a branched chain.

Example 21: The method of any examples herein, particularly example 20, wherein the at least one oxygen containing functional group is-OH or —COOH.

Example 22: The method of any examples herein, particularly examples 15-21, wherein the water-soluble organic compound and/or salts thereof comprise citric acid and its derivatives, ascorbic acid and its derivatives, tannic acid and its derivatives, allic acid and its derivatives, ellagic acid and its derivatives, coumaric acid and its derivatives, cinnamic acid and its derivatives, hydroxycinnamic acid, and its derivatives, hexahydroxydiphenic acid, and its derivatives, quercetin and its derivatives, kaempferol, and its derivatives, catechin and its derivatives, anthocyanin and its derivatives, simple and complex sugars, and their derivatives, amino acids and their derivatives, or any combination thereof.

Example 23: The method of any examples herein, particularly examples 15-22, the water-soluble organic compound and/or salts thereof have a molecular weight of about 50 to about 9,000 g/mol.

Example 24: The method of any examples herein, particularly examples 15-23, wherein the second slurry comprises a plurality of substantially uniformly dispersed nanoparticles comprising calcium carbonate.

Example 25: The method of any examples herein, particularly example 24, wherein the calcium carbonate is polymorphous.

Example 26: The method of any examples herein, particularly examples 15-25, further comprising a step of adding fillers, aggregates, an extra hydraulic cementitious material, or a combination thereof.

Example 27: The method of any examples herein, particularly examples 15-26, wherein the aggregates comprises silica sand, natural sand, crushed stone aggregates, gravel, ground glass, recycled foundry sand, bottom ash, slag, or any combination thereof.

Example 28: The method of any examples herein, particularly examples 15-27, wherein the carbon-dioxide-rich gas is obtained from a post-combustion flue gas, or where the carbon-dioxide-rich gas is a by-product of a manufacture of cement, or a combination thereof.

Example 29: The method of any examples herein, particularly examples 15-28, further comprises a step of forming an article.

Example 30: The method of any examples herein, particularly example 29, wherein the article comprises a concrete, a tile, a brick, a paver, a panel, a synthetic stone, or any combination thereof.

Example 31: The method of any examples herein, particularly examples 29-30, wherein the article exhibits a compressive strength of at least 10% stronger when compared with a substantially identical reference article comprising a substantially identical composition in the absence of the water-soluble organic compound and/or salts thereof.

Example 32: The method of any examples herein, particularly examples 29-31, wherein the article exhibits a carbon footprint of at least 10% lower when compared with a substantially identical reference article comprising a substantially identical composition in the absence of the water-soluble organic compound and/or salts thereof.

Example 33: A composition made by the method of any examples herein, particularly examples 15-28

Example 34: An article comprising a composition of any examples herein, particularly example 33.

Example 35: A method comprising: a) contacting a first cementitious material with a water-soluble organic compound and/or salts thereof to form a first slurry; b) contacting the first slurry with a carbon-dioxide-rich gas to form a second slurry; wherein the second slurry comprising carbonates; and c) drying and grinding the second slurry into fine powders with a size smaller than about 0.15 mm.

Example 36: A composition made by the method of any examples herein, particularly example 35.

Example 37: A method comprising: a) providing the composition of any examples herein, particularly examples 1-10, claim 33, or 36 and b) forming an article.

Example 38: The method of any examples herein, particularly example 37, wherein the article is a concrete, a tile, a brick, a paver, a panel, a synthetic stone, or any combination thereof.

Example 39: The method of any examples herein, particularly examples 37-38, wherein the article exhibits a compressive strength of at least 10% when compared with a substantially identical reference article comprising a substantially identical composition in the absence of the water-soluble organic compound and/or salts thereof.

Example 40: The method of any examples herein, particularly examples 37-39, wherein the article exhibits a carbon footprint of at least 10% lower when compared with a substantially identical reference article comprising a substantially identical composition in the absence of the water-soluble organic compound and/or salts thereof.

Example 41: A method of forming a composition comprising: a) mixing a washing water with a waste concrete comprising a first cementitious material to form a diluted mixture of the waste concrete; b) removing aggregates from the mixture of the waste concrete to form a waste concrete slurry; c) contacting a waste concrete slurry with a water-soluble organic compound and/or salts thereof to form a first slurry; d) contacting the first slurry with a carbon-dioxide-rich gas to form a second slurry; and e) adding a second cementitious material to the second slurry to form the composition.

Example 42: The method of any examples herein, particularly example 41, wherein the composition comprises: a) a total of about 80 wt % to about 99 wt % cementitious material comprising both the first and second cementitious materials; b) about 0.05 wt % to about 3 wt % of a water-soluble organic compound and/or salts thereof; and c) about 1 wt % to about 20 wt % of carbon dioxide.

Example 43: The method of any examples herein, particularly example 41 or 42, wherein the washing water is collected from washing a concrete containing vessels.

1. A composition comprising:
a) about 80 wt % to about 99 wt % of a cementitious material;
b) about 0.05 wt % to about 3 wt % of a water-soluble organic compound and/or salts thereof, wherein the water-soluble organic compound and/or salts thereof comprise at least one oxygen containing functional group along a main chain or a branched chain; and
c) about 1 wt % to about 20 wt % of carbon dioxide.

2. The composition of claim 1, wherein the cementitious material comprises Portland cement, calcium aluminate cement, calcium silicate, magnesium silicate, calcium phosphate cement, calcium aluminate sulfonate cement, fly ash, silica fume, slaked lime, cement kiln dust, limestone fines, ground granulated blast furnace slag, recycled cement mixtures, recycled concrete mixtures, an industrial waste stream comprising at least one of calcium or magnesium, cement waste, concrete waste, and combinations of thereof.

3. (canceled)

4. The composition of claim 1, wherein at least one oxygen containing functional group is-OH or —COOH.

5. The composition of claim 1, wherein the cementitious material is hydraulic.

6. (canceled)

7. The composition of claim 1, wherein the water-soluble organic compound and/or salts thereof comprise citric acid and its derivatives, ascorbic acid and its derivatives, tannic acid and its derivatives, allic acid and its derivatives, ellagic acid and its derivatives, coumaric acid and its derivatives, cinnamic acid and its derivatives, hydroxycinnamic acid, and its derivatives, hexahydroxydiphenic acid, and its derivatives, quercetin and its derivatives, kaempferol, and its derivatives, catechin and its derivatives, anthocyanin and its derivatives, simple and complex sugars, and their derivatives, amino acids and their derivatives, or any combination thereof, and wherein the water-soluble organic compound and/or salts thereof has a molecular weight of about 50 to about 9,000 g/mol.

8. (canceled)

9. The composition of claim 1, wherein the composition further comprises a filler, an aggregate material, an extra hydraulic cementitious material, or a combination thereof.

10. (canceled)

11. An article comprising the composition of claim 1, wherein the article comprises a concrete, a tile, a brick, a paver, a panel, a synthetic stone, or any combination thereof.

12. (canceled)

13. The article of claim 11, wherein the article exhibits a compressive strength of at least about 10% higher when compared with a substantially identical reference article comprising a substantially identical composition in the absence of the water-soluble organic compound and/or salts thereof, and/or the article exhibits a carbon footprint of at least about 10% lower when compared with a substantially identical reference article comprising a substantially identical composition in the absence of the water-soluble organic compound and/or salts thereof.

14. (canceled)

15. A method of forming a composition comprising:
a) contacting a first cementitious material with a water-soluble organic compound and/or salts thereof to form a first slurry, wherein the water-soluble organic compound and/or salts thereof comprise at least one oxygen containing functional group along a main chain or a branched chain;
b) contacting the first slurry with a carbon-dioxide-rich gas to form a second slurry; and
c) adding a second cementitious material to the second slurry to form the composition,
wherein the formed composition comprises:
i) a total of about 80 wt % to about 99 wt % cementitious material comprising both the first and second cementitious materials;
ii) about 0.05 wt % to about 3 wt % of a water-soluble organic compound and/or salts thereof; and
iii) about 1 wt % to about 20 wt % of carbon dioxide.

16. (canceled)

17. The method of claim 15, wherein the water-soluble organic compound and/or salts thereof is present as a solution.

18. The method of claim 15, wherein the first cementitious material comprises Portland cement, calcium aluminate cement, calcium silicate, magnesium silicate, calcium phosphate cement, calcium aluminate sulfonate cement, fly ash, silica fume, slaked lime, cement kiln dust, limestone fines, ground granulated blast furnace slag, recycled cement mixtures, recycled concrete mixtures, an industrial waste stream comprising at least one of calcium or magnesium, cement waste, concrete waste, and combinations of thereof, and/or wherein the second cementitious material comprises Portland cement.

19. (canceled)

20. (canceled)

21. (canceled)

22. The method of claim 15, wherein the water-soluble organic compound and/or salts thereof comprise citric acid and its derivatives, ascorbic acid and its derivatives, tannic acid and its derivatives, allic acid and its derivatives, ellagic acid and its derivatives, coumaric acid and its derivatives, cinnamic acid and its derivatives, hydroxycinnamic acid, and its derivatives, hexahydroxydiphenic acid, and its derivatives, quercetin and its derivatives, kaempferol, and its derivatives, catechin and its derivatives, anthocyanin and its derivatives, simple and complex sugars, and their derivatives, amino acids and their derivatives, or any combination thereof; and wherein the water-soluble organic compound and/or salts thereof have a molecular weight of about 50 to about 9,000 g/mol.

23. (canceled)

24. The method of claim 15, wherein the second slurry comprises a plurality of substantially uniformly dispersed nanoparticles comprising calcium carbonate.

25. (canceled)

26. The method of claim 15, further comprising a step of adding fillers, aggregates, an extra hydraulic cementitious material, or a combination thereof.

27. (canceled)

28. (canceled)

29. The method of claim 15, further comprises a step of forming an article, wherein the article comprises a concrete, a tile, a brick, a paver, a panel, a synthetic stone, or any combination thereof.

30. (canceled)

31. The method of claim 29, wherein the article exhibits a compressive strength of at least 10% stronger when compared with a substantially identical reference article comprising a substantially identical composition in the absence of the water-soluble organic compound and/or salts thereof; and/or wherein the article exhibits a carbon footprint of at least 10% lower when compared with a substantially identical reference article comprising a substantially identical composition in the absence of the water-soluble organic compound and/or salts thereof.

32. (canceled)

33. (canceled)

34. (canceled)

35. A method comprising:
a) contacting a first cementitious material with a water-soluble organic compound and/or salts thereof to form a first slurry;
b) contacting the first slurry with a carbon-dioxide-rich gas to form a second slurry; wherein the second slurry comprising carbonates; and
c) drying and grinding the second slurry into fine powders with a size smaller than about 0.15 mm.

36. (canceled)

37. (canceled)

38. (canceled)

39. (canceled)

40. (canceled)

41. A method of forming a composition comprising:
a) mixing a washing water with a waste concrete comprising a first cementitious material to form a diluted mixture of the waste concrete;
b) removing aggregates from the mixture of the waste concrete to form a waste concrete slurry;
c) contacting a waste concrete slurry with a water-soluble organic compound and/or salts thereof to form a first slurry; d)
d) contacting the first slurry with a carbon-dioxide-rich gas to form a second slurry; and
e) adding a second cementitious material to the second slurry to form the composition; wherein the formed composition comprises:
i) a total of about 80 wt % to about 99 wt % cementitious material comprising both the first and second cementitious materials;
ii) about 0.05 wt % to about 3 wt % of a water-soluble organic compound and/or salts thereof; and
iii) about 1 wt % to about 20 wt % of carbon dioxide.

42. (canceled)

43. The method of claim 41, wherein the washing water is collected from washing concrete-containing vessels.
